(19) United States
(12) Patent Application Publication
(10) Pub. No.: US 2005/0206804 A1
(43) Pub. Date: Sep. 22, 2005

(54) Liquid crystal display unit

(76) Inventor: Kazutaka Hara, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(21) Appl. No.: 10/507,120

(22) PCT Filed: Mar. 13, 2003
(86) PCT No.: PCT/JP03/02984

§ 371 Date: Sep. 10, 2004

(30) Foreign Application Priority Data
Mar. 14, 2002 (JP) 2002-70183

(51) Int. Cl. G02F 1/1335

(52) U.S. Cl. 349/62

(57) ABSTRACT

A liquid crystal display device includes a backlight 1, a collimating element for collimating incoming light from the backlight and transmitting the collimated light, a liquid crystal cell for allowing the light coming from the collimating element to pass therethrough, and a viewing angle widening element 4 for widening the viewing angle by diffusing the light transmitted through the liquid crystal cell, in which the collimating element does not have a periodic pattern structure that allows Moire fringes or interference patterns seen in optical observation from a display side to be formed relative to a periodic pattern structure of another optical member of the liquid crystal display device.

### FIELD OF THE INVENTION

The present invention relates to a liquid crystal display device and more particularly to a liquid crystal display device that can be designed in a thin, low profile configuration while producing an excellent display quality and a wide viewing angle.

### BACKGROUND OF THE INVENTION

There is a hitherto known technique for widening the viewing angle of a liquid crystal display device, which involves collimating the backlight, radiating the collimated light to a liquid crystal cell, retrieving only the light passing near the front which delivers an image with good contrast ratio and color tone, and dispersing the same, thereby allowing the same quality display of image as the display of the front to be observed at any angle.

In a liquid crystal display device to which the above viewing angle widening method is applied, a technique realizing the collimation of the backlight causes various practical problems. For example, in a conventional collimation technique for backlight hitherto known (e.g., Japanese Patent Application Laid-open Nos. Hei-10-333147 and Hei-10-255528), there cause various problems when putting such a technology into practical use, such as a thick profile backlight, deteriorated efficiency in light utilization and increased costs.

As illustrated in FIG. 5, in a conventional TN (Twisted Nematic) liquid crystal display device (a liquid crystal display device to which no viewing angle widening technology is applied), a high contrast ratio is achieved only in the area within about ±20° relative to the front. As a technique to magnify only the light near the front which achieves a good quality of display, it can be cited a technique which collimates the light output of the backlight to about ±20° and diffuses the light near the front after it has transmitted through the liquid crystal cell, thereby widening the viewing angle.

Where a prism sheet (e.g., BEF (Brightness Enhance Film) manufactured by 3M Corporation) is used as a collimating element for the backlight, the maximum collimation degree is about ±40°. Even varying the shape of an optical transmission member which constitutes the backlight achieves only a collimated degree of about ±40°. These approaches therefore are hard to meet the requirements expected as the viewing angle widening element for LCDs. The optical system such as BEF, which relies on a prism effect which distorts the light due to the refractive index difference between an irregular film surface and air, is impossible to be laminated to another film with an adhesive agent or tackiness agent since it necessarily needs an air interface therebetween. This causes a problem that during the fabrication process, dusts or foreign matters are trapped in the air interface or a surface is damaged.

Where a light-shielding louver film (e.g., a light control film manufactured by 3M Corporation) as illustrated in FIG. 6 is used as a conventionally existing collimating element, light absorption loss is significant, causing a brightness problem.

For example, as illustrated in FIG. 6(b), where the width W of each of light-shielding louvers 5 (rectangular pieces which absorb a black colored light) together constituting a light-shielding louver film 20 is 13 μm and the pitch interval P between the louvers 5 is 250 μm, the maximum transmittance of the light-shielding louver film 20 (a transmittance when parallel light rays are incident perpendicularly on the film 20 in a thickness direction) is 95% (250/(250+13)=0.95). However, in order to achieve a collimation degree of ±20° for the light having passed the light-shielding louver film 20, the thickness T of each light-shielding louver 5 illustrated in FIG. 6(a) must be 680 μm (the collimation degree of the transmitted light depends on the pitch interval P and the thickness T). For collimating the light parallel to the lengthwise direction of the light-shielding louvers 5, it is necessary to laminate two light-shielding louver films 20 to each other with their alignment directions orthogonal to each other, as illustrated in FIG. 6(c). This results in a thickness of about 1.4 mm in total. In this case, a maximum transmittance of about 90% is secured and the collimation reaches a good level as well, but a problem of increasing the thickness arises.

Where the thickness of each light-shielding louver 5 and the pitch interval P are both 13 μm, the maximum transmittance is 50%. In order to achieve a collimation degree of ±20° for the transmitted light, the thickness T is 35 μm, which results in 70 μm in total with two films 20 laminated to each other. The transmittance after the lamination of the two films is reduced to 25%.

Likewise, where the thickness T of each light-shielding louver 5 is 13 μm; the pitch interval P is 250 μm; and the thickness is 100 μm, the maximum transmittance is 95%, so that even if two films are laminated to each other, the maximum transmittance can be kept at 90% and the thickness is 200 μm in total; however, the collimation degree of the transmitted light is about ±50° which makes it impossible to obtain the collimated light.

As described above, where the light-shielding louver film is used as the collimating element, the thickness, transmittance (brightness) or collimation degree is necessarily deteriorated and therefore many practical problems are caused.

For a liquid crystal display device used in a notebook-size personal computer or a mobile phone, the thickness of the collimating element is preferably not more than 200 μm and more preferably not more than 1001 μm.

From the above point of view, the collimating element in the form of a mirror, lens, prism, optical transmission member or the like significantly increases in thickness and weight, and therefore is unlikely to be an effective element except for a specific field of use such as a projector.

Therefore, there is a demand for a collimating element in the form of a thin film that is capable of collimating the backlight to a range enabling a good viewing angle characteristic of the liquid crystal display device, that is, about ±20° or smaller, while reducing the absorption loss.

In the collimating element using the aforementioned light-shielding louver film, a microlens array, a microprism array or the like, Moire fringes are formed between their fine pattern structure and pixels of a liquid crystal cell, causing difficulty to produce a good display. That is, since there is no emission of light from jointed portions of prisms or from a clearance to a lens, all are provided as the collimating element, in-plane variation in density of the transmitted light occurs in a certain pattern, which results in occurrence of Moire fringes between the collimating element and pixels of the liquid crystal cell. In order to prevent occurrence of Moire fringes, a diffusing element may be inserted into a portion on the light emission side of the collimating element, but poses a problem of deteriorating the collimation degree. The same is also applicable to interference patterns caused between the collimating element and the liquid crystal cell.

Even if Moire fringes or interference patterns between the pixels of the liquid crystal cell and the collimating element are weakened by changing their pattern (cycle) intensity, Moire fringes or interference patterns may occur between the pattern structure of the viewing angle widening element located on the display side of the liquid crystal cell and the pattern structure of the collimating element. That is, where such as a microlens array, microprism or the like having the pattern structure with a certain periodicity is employed for the viewing angle widening element, Moire fringes or interference patterns may occur between the pattern structure of the viewing angle widening element and the pattern structure of the collimating element.

A special care must be taken to determine the size, arrangement manner or the like of the pattern structure of the viewing angle widening element in order to prevent the occurrence of Moire fringes or interference patterns relative to the pixels of the liquid crystal cell. This design for prevention of the occurrence of Moire fringes or interference patterns is the same as the design for prevention of the occurrence of Moire fringes or interference patterns made in the collimating element relative to pixels of the liquid crystal cell. This poses a problem that Moire fringes or interference patterns are easy to occur even between members which have been treated so as not to occur Moire fringes or interference patterns, that is, between the viewing angle widening element and the collimating element.

For example, in a case where a pattern structure having such a size as not to cause Moire fringes or interference patterns relative to the pixels of the liquid crystal cell is employed for the collimating element, a pattern structure having such a size as not to cause Moire fringes or interference patterns relative to the pixels of the liquid crystal cell is also employed for the viewing angle widening element, so that they necessarily have a size capable of causing Moire fringes or interference patterns. The same is applied to the arrangement manner (angle, alignment, etc.) of both elements, and therefore there is a problem that the permissible design flexibility is necessarily limited in view of the prevention of occurrence of Moire fringes or interference patterns; in other words, the selectable range of the optical system for these elements is greatly limited.

It has also been proposed to utilize a hologram as the collimating element (see for example the specification of U.S. Pat. No. 4,984,872). However, with hologram materials, only a small effect of lowering the transmittance of oblique incident light can be produced by allowing perpendicularly incident light to pass therethrough while diffusing the oblique incident light. Where the hologram is located in a diffusing light source (backlight), it is difficult to converge highly directional light rays. Also, hologram materials are soft and therefore easy to be affected by stress distortion, posing a problem of deteriorating the optical reliability.

As described above, a conventional liquid crystal display device equipped with the collimating element and the viewing angle widening element has a limited design flexibility for the optical reason resulting from the fine pattern structure of both the elements and therefore there is a problem of making it difficult to put a liquid crystal display device with a high quality display into practical use.

### SUMMARY OF THE INVENTION

The present invention has been made to solve the problems associated with the above prior arts. It is a first object of the present invention to provide a liquid crystal display device that provides a wide viewing angle and an excellent display quality without occurrence of Moire fringes or interference patterns. It is a second object of the present invention to provide a liquid crystal display device that is capable of being manufactured in a thin, low-profile configuration.

In order to achieve the first object of the present invention, there is provided a liquid crystal display device which includes a backlight, a collimating element for collimating incoming light from the backlight and transmitting the collimated light, a liquid crystal cell for allowing the light coming from the collimating element to pass therethrough, and a viewing angle widening element for widening the viewing angle by diffusing the light transmitted through the liquid crystal cell, in which the collimating element does not have a periodic pattern structure that allows Moire fringes or interference patterns seen in optical observation from a display side to be formed relative to a periodic pattern structure of another optical member of the liquid crystal display device.

According to the present invention, the collimating element for transmitting the collimated light to the liquid crystal cell and the viewing angle widening element for widening the viewing angle by diffusing the light transmitted through the liquid crystal cell achieves a liquid crystal display device with wide viewing angle. Also, with the collimating element which does not have a periodic pattern structure that allows Moire fringes or interference patterns seen in optical observation from a display side to be formed relative to a periodic pattern structure of another optical member (the liquid crystal cell, the viewing angle widening element or the like) of the liquid crystal display device, the liquid crystal display device as provided provides a high quality display without occurrence of Moire fringes or interference patterns.

Preferably, the collimating element is a bandpass filter in order to achieve the second object of the present invention.

According to the present invention, the transmission wavelength band of the bandpass filter is optimized so that only the light collimated toward the front side can be transmitted. Since the bandpass filter is formed such as by vapor deposition of a material into a multilayer structure, it does not have a periodic pattern structure that allows Moire fringes or interference patterns to be formed relative to a periodic pattern structure of another optical member of the liquid crystal device. This is also significantly advantageous in the fact that the vapor deposition of a material can achieve a thin layered structure, a thin bandpass filter and hence a thin low-profile liquid crystal display device.

The bandpass filter may be made of a cholesteric liquid crystal polymer material, as well as made by vapor deposition of a material into a multilayer structure or laminating resin materials respectively having different refractive indexes into a multilayer structure.

In a case where the bandpass filter is formed by laminating the resin materials into a multilayer structure, the multilayer structure can be achieved by extruding the resin materials into a multilayer structure and then drawing the same, or thin film deposition of the resin materials.

Preferably, the collimating element has a thickness of not more than 200 μm so that the liquid crystal display device equipped with the collimating element can be manufactured in a thin, low profile configuration. The thickness of the collimating element is more preferably not more than 100 μm and further preferably not more than 50 μm.

The collimation degree of the light coming from the collimating element is preferably within ±20° so that an area of a conventional TN liquid crystal display device with a high contrast ratio can efficiently be utilized. The collimation degree of the light is more preferably within ±15° and further preferably within ±10°.

A light source of the backlight preferably emits a bright-line spectrum. Specifically, as the light source, a three-band cold cathode lamp, a light emitting diode, an electroluminescence device or the like may be used.

The viewing angle widening element is preferably a diffusing plate that does not substantially cause backscattering and does not substantially destroy a polarized state.

According to the present invention, since the viewing angle widening element does not substantially cause backscattering, it is possible to prevent lowering of the transmittance due to the presence of the viewing angle widening element. Also, since the viewing angle widening element does not substantially destroy a polarized state, it can be located adjacent to the liquid crystal cell (e.g., between the liquid crystal cell, and a polarizer on the display side of the liquid crystal cell), thus preventing influences from blurred pixels of the liquid crystal cell or the like.

### BRIEF DESCRIPTION OF THE DRAWINGS

FIG. 1 is a longitudinal cross sectional view illustrating a schematic arrangement of an essential portion of the liquid crystal display device according to a first embodiment of the present invention.

FIG. 2 is a diagram illustrating the transmission spectral characteristics of the bandpass filter of the first embodiment.

FIG. 3 is a diagram illustrating the viewing angle characteristics of the liquid crystal display device of the first embodiment.

FIG. 4 is a diagram illustrating the transmission spectral characteristics of the bandpass filter according to a second embodiment of the present invention.

FIG. 5 is a diagram illustrating the viewing angle characteristics of the conventional liquid crystal display device.

FIG. 6 illustrate the schematic arrangement of the light-shielding louver film as a conventional collimating element. Specifically, FIGS. 6(a), 6(b) and 6(c) are respectively a perspective view, a plan view, and a perspective view with two films being laminated together.

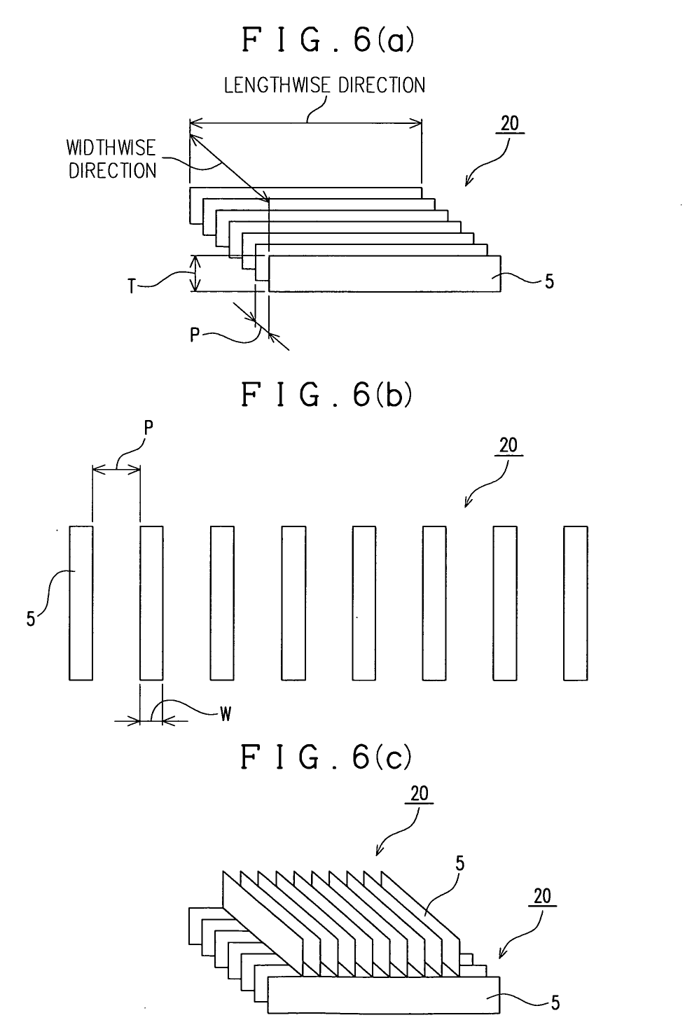

FIG. 7 is a diagram illustrating the transmission spectral characteristics of a selective-reflection, circular polarizing film of a third embodiment of the present invention.

### DETAILED DESCRIPTION OF THE PREFERRED EMBODIMENT

Now, the description will be made for an embodiment of the present invention with reference to the drawings attached hereto.

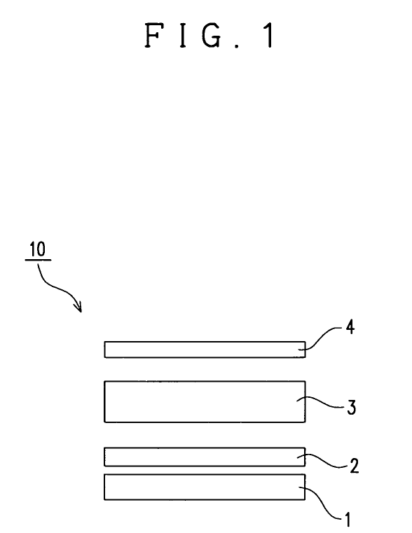

FIG. 1 is a longitudinal cross sectional view illustrating a schematic arrangement of an essential portion of the liquid crystal display device according to a first embodiment of the present invention. As illustrated in FIG. 1, a liquid crystal display device 10 of this embodiment includes a backlight 1, an collimating element 2 for collimating incoming light from the backlight 1 and transmitting the collimated light, a liquid crystal cell 3 for allowing the light coming from the collimating element 2 to transmit therethrough, and a viewing angle widening element 4 for widening the viewing angle by diffusing the light transmitted through the liquid crystal cell 3.

The backlight 1 is a light source which emits bright-line spectrum, such as a light emitting diode and an electroluminescence device, as well as a three-band cold cathode lamp, which is designed to emit surface light on the collimating element 2. As the backlight 1, it may be a so-called direct backlight as illustrated in FIG. 1, or a sidelight backlight located on the lateral side to emit surface light via an optical transmission member.

The collimating element 2 is designed not to have a periodic pattern structure that allows Moire fringes or interference patterns seen in optical observation from a display side (from an upper part of FIG. 1) of the liquid crystal display device 10, to be formed relative to a periodic pattern structure of another optical member (the liquid crystal cell 3, the viewing angle widening element 4 or the like) of the liquid crystal display device 10. In this embodiment, the collimating element 2 is provided in the form of a bandpass filter (the collimating element 2 will be hereinafter referred as “a bandpass filter 2”).

The bandpass filter 2 can be made by using a cholesteric liquid crystal polymer material and utilizing the angular dependency of selective reflection of cholesteric liquid crystal, as disclosed in Japanese Patent Application Nos. 2001-60005 and 2000-281382. The bandpass filter 2 can achieve collimation of light coming from the backlight 1 without absorption lose of light from the backlight 1.

The same function can be realized by the bandpass filter 2 that is formed by laminating resin materials having respectively different refractive indexes on a transparent substrate.

Thus, the collimation of light coming from the backlight 1 by utilizing the bandpass filter 2 can easily produce highly collimated light in easy manner than ever. Particularly, in a case where the light source of the backlight 1 emits a bright-line spectrum, as a three-band cold cathode lamp, it is possible to allow transmission of only the light collimated toward the front side by optimizing the transmission wavelength band of the bandpass filter 2 according to the bright-line spectrum. The bandpass filter 2 is a filter that inherently absorbs no light, and therefore reflected, non-collimated light (obliquely incident light) is returned to the backlight 1 and again reflected towards the bandpass filter 2, so that only the forward-directed light component of this rereflected light passes through the bandpass filter 2. Accordingly, by a so-called light recycling effect enabling repetition of the above actions, the forward (perpendicular) light intensity of light, which passes through the bandpass filter 2, is enhanced. Thus, it is possible to produce collimated light at high efficiency.

As described above, by utilizing the selective reflection of circularly polarized light of cholesteric liquid crystal, the collimated light transmitted through the bandpass filter 2 turns into circularly polarized light, as disclosed in Japanese Patent Application Nos. 2001-60005 and 2000-281382. This polarized light is forced into linearly polarized light by a quarter wavelength plate, thus achieving highly efficient collimating with substantially no absorption loss.

The bandpass filter 2 having the above arrangement prevents visual observation of its in-plane fine pattern structure, and therefore does not form Moire fringes or interference patterns relative to pixels of the liquid crystal cell 3 or the viewing angle widening element 4, as well as a black matrix (not shown), or an anti-glare layer (not shown) provided on the outermost side of the liquid crystal display device, or other optical members, thus producing advantages of providing an excellent display quality and significantly increasing the design flexibility of the viewing angle widening element 4.

Further, in comparison with a collimating element using a conventional microlens array, a microprism array or the like, the thickness of the thin film layers of the bandpass filter 2 excluding the substrate is about several micrometers to about several tens micrometers, which facilitates a significantly thin, low-profile design. Also, since an air interface is not required, the bandpass filter 2 can be bonded to the backlight 1 or the like for use. This greatly contributes to ease of handling.

More specifically, for the bandpass filter 2 using a cholesteric liquid crystal polymer material, a phase difference plate to be combined with this material is made up of conventional two oriented films (thickness: 50 μm). Even if they are laminated together by a tackiness agent, the total thickness reaches only about 150 μm. In a case where the phase difference plate is made of a liquid crystal polymer material, and adjacent layers are directly bonded to each other, it is possible to reduce the thickness to about 50 μm. For the bandpass filter 2 formed by vapor deposition of a material, the thickness except the substrate can be reduced to about 3 μm.

The viewing angle widening element 4 is provided to produce a good quality and uniform display across the entire viewing angle by diffusing, after the transmission through the liquid crystal cell 3, light near the front having good display characteristics obtained by the collimating element 2. As the viewing angle widening element 4, while various diffusing plates can be employed as long as they are capable of diffusing light, diffusing plates (an adhesive diffusing plates) capable of causing substantially no backscattering, as disclosed in Japanese Patent Application Laid-open Nos. 2000-347006 and 2000-347007 are preferably used. With a diffusing plate causing substantially no backscattering, it is possible to prevent lowering of the transmittance due to the presence of the viewing angle widening element 4 and lowering of the contrast ratio without allowing external light (room light, sunlight or the like) entered from the display side of the liquid crystal cell 3 to be scattered backward (that is, toward the display side) by the diffusing plate. The liquid crystal display device 10 having these characteristics can be preferably used as a liquid crystal display device for a digital camera, video camera or the like, as well as being used in DTP (desktop publishing) which frequently necessitates visual observation of a displayed image while changing the display orientation from vertical to horizontal or vice versa by changing the orientation of the liquid crystal display device 10.

The viewing angle widening element 4 can be disposed on any one of the front and rear sides of a polarizer (not shown) disposed on the display side of the liquid crystal cell 3, as long as it is on the display side of the liquid crystal cell 3. However, in order to prevent influences from blurred pixels of the liquid crystal cell 3 and lowering of the contrast ratio due to possibly remaining small backscattering, it is preferable to dispose the viewing angle widening element 4 as close as possible to the liquid crystal cell 3 between the polarizer and the liquid crystal cell 3 (that is, on the rear side of the polarizer). Where the viewing angle widening element 4 is disposed in this position, it is preferably the one which does not substantially destroy a polarized state. For example, it is preferable to use a diffusing plate having fine particles dispersed therein (the adhesive diffusing layer) (haze value of about 80%-90%), as disclosed in Japanese Patent Application Laid-open Nos. 2000-347006 and 2000-347007.

Also, as the viewing angle widening element 4, it is possible to employ a conventional micro lens array film, hologram film or the like having a periodic pattern inside structure. In this case, conventionally, Moire fringes or interference patters are likely to occur between a black matrix which constitutes a liquid crystal display device, and the pattern structure of a micro lens array, a prism array, a light-shielding louver, a micro mirror array or the like which constitutes a conventional collimating element. However, as mentioned above, the bandpass filter 2 as the collimating element 2 of this embodiment prevents visual observation of its in-plane fine pattern structure and produces no periodic modulation of light coming from the collimating element 2 so that there is no need to take into account the compatibility to the viewing angle widening element 4, the order of the alignment or the like. Accordingly, as the viewing angle widening element 4, various forms can be selected as long as they do not form Moire fringes or interference patterns relative to an optical member (a black matrix or the like) other than the viewing angle widening element 4.

For the liquid crystal display device 10 using as the viewing angle widening element 4 a diffusing plate made of a material such as a hologram material having anisotropy in light-diffusion characteristics, viewing angle characteristics on the vertical and lateral sides can be selectively improved and therefore it is preferably used for example as a liquid crystal display device for a widescreen TV.

Now, the detailed description will be made for the bandpass filter 2.

The bandpass filter 2 is of a multilayer structure formed by vacuum vapor deposition, sputtering, electron-beam codeposition (EB), resin film coating or the like, or use of oriented films of a resin material extruded into a multilayer structure, or crushing the lamination of the bandpass filter into scaly flakes and embedding them in a resin. Thus, the bandpass filter 2 is formed by thin-film lamination with materials having respectively different refractive indexes. More specific description will be made below.

(1) Case where the Bandpass Filter is Formed by Laminating Thin Films Made of a Vapor Deposited Material

A metal oxide, dielectric material or the like such as TiO₂, ZrO₂ or ZnS for a high refractive index material, and a metal oxide, dielectric material or the like such as SiO₂, MgF₂, Na₃AlF₆ or CaF₂ for a low refractive index material are respectively used, and these materials respectively having different refraction indexes are vapor-deposited on the transparent substrate. Thus, the bandpass filter 2 is produced.

(2) Case where the Bandpass Filter is Formed by Laminating Thin Films Made of a Resin Composition

For example, a halogenated resin composition represented by polyethylene naphthalate, polyethylene terephthalate, polycarbonate, vinyl carbazole and brominated acrylate, a high refractive index resin material such as a resin composition with ultrafine particles of a high refractive index inorganic material embedded therein, a fluorocarbon resin material represented by such as trifluoroethyl acrylate, and a low refractive index resin material such as an acrylic resin represented by polymethyl methacrylate may be used, in which these materials having such different refractive indexes are laminated on the transparent substrate. Thus, the bandpass filter 2 can be produced.

(3) Case where the Bandpass Filter is Formed by Using a Liquid Crystal Polymer

A thin film of cholesteric spiral pattern for enabling selective light reflection is formed on a transparent substrate by lyotropic liquid crystal or thermotropic liquid crystal. The thin film is subjected to UV polymerization, drying, heat-curing or the like so as to have a fixed structure so that the bandpass filter can be made.

While the material of the transparent substrate used in the above (1)-(3) is not limited to a specific one, a polymer, a glass material or the like is generally used. As examples of the polymer, it can be used a cellulosic polymer such as cellulose diacetate and cellulose triacetate, polyester polymer such as polyethylene terephthalate and polyethylene naphthalate, polymer such as polyolefin polymer and polycarbonate polymer, and the like.

Where a so-called reflection polarizer (which reflects light having a plane of polarization perpendicular to a plane of polarization of a polarizer located on the side of the backlight of the liquid crystal cell 3) is located between the bandpass filter 2 and the backlight 1 so as to increase the quantity of light passing through the bandpass filter 2, it is preferable to use, as the transparent substrate, a film of cellulose triacetate, nonoriented polycarbonate, nonoriented polyethylene terephthalate or ARTON or ZEONOR film, each having a small phase difference.

Now, the description will be made in detail for the setting procedure for setting a selective wavelength allowed through the bandpass filter 2.

The bandpass filter 2 of this embodiment is set to exhibit a maximum transmittance (a wavelength exhibiting a maximum transmittance will be referred to a maximum transmission wavelength) at a wavelength corresponding to a peak wavelength in the emission spectrum of the backlight 1, while having a reflection wavelength with a 50% or more cut rate (a wavelength having a reflectance of not less than 50%) on the longer wavelength side than the maximum transmission wavelength.

As described later, the collimation degree of light passing through the bandpass filter 2 is varied according to the difference between the reflection wavelength and the maximum transmission wavelength, so that this difference can be arbitrarily set based upon each purpose.

That is, the reflection wavelength with a 50% or more cut rate according to the incident angle θ of light into the bandpass filter 2 is approximately derived from the following equation (1):
λ2=λ1×(1−(n0/ne)²×sin²θ)^{1/2} (1)
wherein λ1 represents a value of the reflection wavelength, which reflects 50% or more of perpendicular incident light, λ2 represents a value of the reflection wavelength, which reflects 50% or more of light with θ incident angle, n0 represents a refractive index of an external medium (1.0 for the air interface), ne represents an effective refractive index of the bandpass filter 2 and θ represents an incident angle.

According to the above equation (1), for example, where the reflection wavelength λ1=555 nm and the effective refractive index of the bandpass filter 2 ne=2.0 for a peak wavelength of 545 nm in the emission spectrum of the backlight 1, while they are arranged with leaving air interfaces, the incident angle θ, which enables the reflection wavelength λ2=545 nm, is about ±22 degrees. That is, as far as the incident angle θ is within an angular range of about ±22 degrees, it is possible to obtain a transmittance of 50% or more. (Contrarily, as far as the incident angle θ is out of the angular range of about ±22 degrees, λ2 is smaller than 545 nm (λ2<545 nm); as a result, light of the backlight 1 having a peak wavelength of 545 nm, which is on the longer wavelength side than the aforesaid λ2, 50% or more does not pass through the bandpass filter 2). Likewise, when the reflection wavelength λ1=547 nm, the incident angle θ, which enables the reflection wavelength λ2=545 nm, is about ±10 degrees, while the incident angle θ, which enables the reflection wavelength λ2=545 nm is about ±5 degrees when the reflection wavelength λ1=545.5 nm.

Thus, it is possible to freely control the collimation degree of light passing through the bandpass filter 2 by setting the maximum transmission wavelength of the bandpass filter 2 (peak wavelength in the emission spectrum of the backlight 1) and the reflection wavelength λ1.

Where plural peak wavelengths exist in the emission spectrum of the backlight 1, the same setting procedure can be applied to each wavelength. For example, where a light source of the backlight 1 is a three-band cold cathode lamp, peak wavelength is frequently set at 435 nm for blue light, 545 nm for green light and 610 nm for red light. Accordingly, the reflection wavelength λ1 of the bandpass filter 2 can be set for each peak wavelength.

Specifically, in the above case, the reflection wavelength λ1 is set at 436.6 nm for blue light, 547 nm for green light and 612.3 nm for red light, so that the incident angle θ range becomes about ±10 degrees regardless of the color. That is, regardless of the color, it is possible to control the collimation degree of light passing through the bandpass filter 2 so as to be within an angular range of about ±10 degrees relative to the front.

While the maximum transmittance of each wavelength in the bandpass filter 2 may be varied according to the designed film quality, it is possible to allow the backlight 1 to have an emission spectrum intensity matched to the maximum transmittance of each wavelength by adjusting the amount of a fluorescent material in each color of the light source, which makes up the backlight 1, making the backlight 1 match to the maximum transmittance at each wavelength, or adjusting the power supply to each light emitting diode of the light source (plural light emitting diodes), which constitutes the backlight 1, thus adjusting the color tone of the transmitted light.

As disclosed in Japanese Patent Application Nos. 2001-60005 and 2000-281382, with respect to the angular characteristics of selective reflections of cholesteric liquid crystal where the bandpass filter 2 is made by using a cholesteric liquid crystal material, the wavelength range of selectively reflected light Δλ is derived, based upon the difference Δn in average refractive index of cholesteric liquid crystal, from the following equation (3):
Δλ=Δn×P×cos θ (3)
wherein P represents a pitch interval of the spiral pattern of cholesteric liquid crystal, and θ represents an incident angle.

According to the above equation (3), it is possible to design and control the collimation degree of the transmitted light in the same manner as in the case of the bandpass filter.

It is preferable to dispose a given diffusing plate (not shown) between the bandpass filter 2 and the backlight 1. With this diffusing plate disposed therebetween, it is possible to enhance efficient utilization of light coming from the backlight 1 by reusing a part of light (a component incident perpendicularly to the bandpass filter 2), which light has been obliquely incident to the bandpass filter 2, reflected thereon and diffused by the diffusing plate. The diffusing plate may be formed with an uneven surface so as to achieve light diffusing function or by a method, in which fine particles having different refractive indexes are embedded in a resin substance. In this connection, particularly where the diffusing plate is located close to the backlight 1, light interference in a clearance between the diffusing plate and the backlight 1 may cause a Newton ring. The diffusing plate of this embodiment is formed so as to have an uneven surface on the side facing the backlight 1, which limits occurrence of the Newton ring and hence maintains the quality of the backlight 1. A layer which has an uneven surface for preventing the occurrence of the Newton ring and achieves the light diffusion may be formed on the bandpass filter on the side of the backlight 1.

The bandpass filter 2 can exhibit the optical function whether it is bonded to the liquid crystal cell 3 or the backlight 1. For example, it is possible to protect an optical function surface (a surface opposite to the substrate) of the bandpass filter 2 by bonding the same to the liquid crystal cell 3 via an adhesive or tackiness agent, while having the substrate of the bandpass filter 2 exposed to the air interface. It is also possible to protect the optical function surface by bonding the optical function surface to the backlight 1 via an adhesive or tackiness agent.

### EXAMPLES

Examples and Comparative Examples as presented will make the characteristics of the present invention more clear.

### Example 1

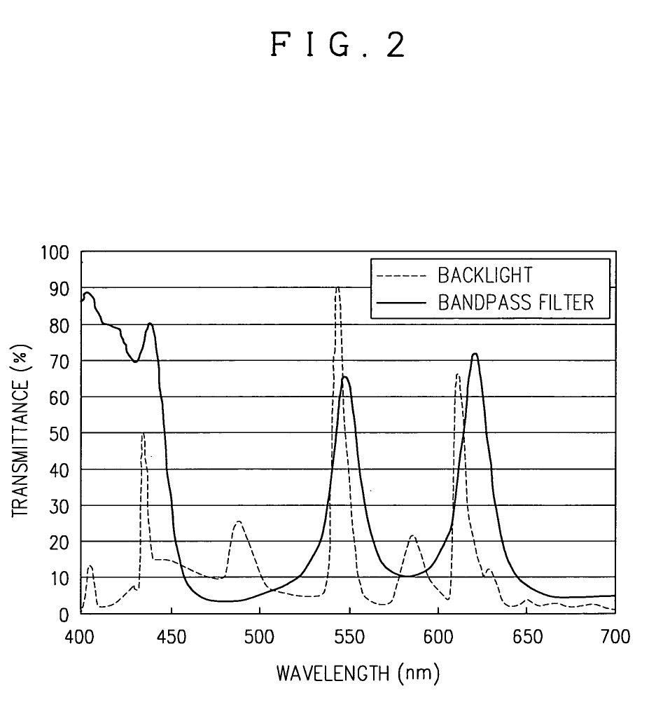

Fifteen layers of vapor-deposited thin films of TiO₂/SiO₂, respectively having thickness as designed in Table 1, were laminated on a substrate of a polyethylene terephthalate film having a thickness of 50 μm (a total thickness: about 53 μm) to prepare a bandpass filter having the transmission spectral characteristics, as illustrated in FIG. 2.

TABLE 1

| | | FILM |
|---|---|---|
| | | THICKNESS |
| LAYER | MATERIAL | [nm] |
| 15 | TiO₂ | 92.1 |
| 14 | SiO₂ | 130.1 |
| 13 | TiO₂ | 68.3 |
| 12 | SiO₂ | 97.2 |
| 11 | TiO₂ | 63.2 |
| 10 | SiO₂ | 88.2 |
| 9 | TiO₂ | 152.1 |
| 8 | SiO₂ | 92.8 |
| 7 | TiO₂ | 70.7 |
| 6 | SiO₂ | 50.3 |
| 5 | TiO₂ | 148.6 |
| 4 | SiO₂ | 95.8 |
| 3 | TiO₂ | 65.5 |
| 2 | SiO₂ | 96.9 |
| 1 | TiO₂ | 65.3 |

SUBSTRATE

With the diffusing plate mounted on an optical transmission member of a conventional non-directional backlight (the emission spectrum of a cold cathode light source used is shown in FIG. 2) and the bandpass filter mounted thereon, it has been found that the light transmitted through the bandpass filter is collimated to about ±20° relative to the front.

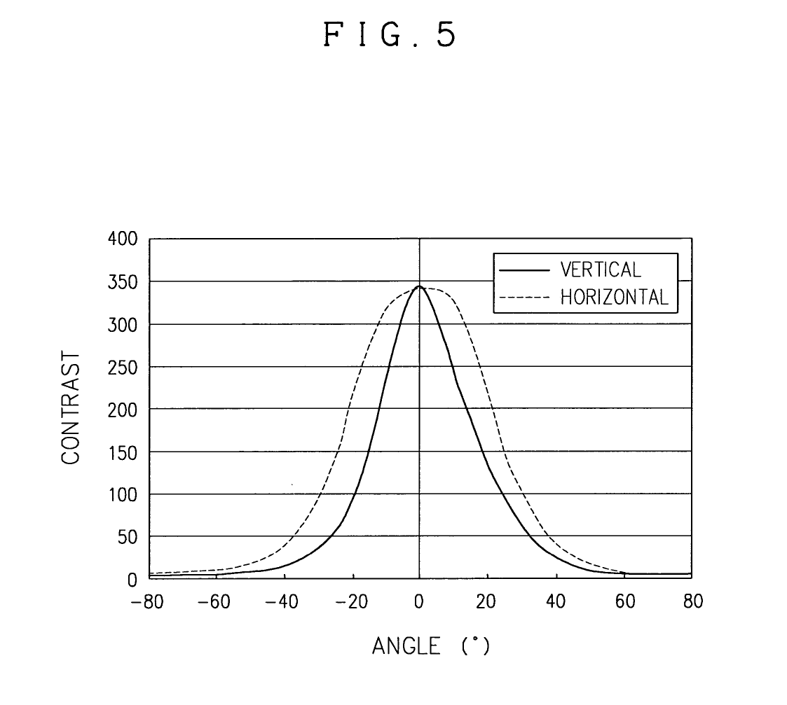

The optical system was incorporated into a TFT liquid crystal panel having viewing angle characteristics as illustrated in FIG. 5. More specifically, in consideration of the handling capability, the vapor deposited surface of the bandpass filter was bonded to the light-source-side polarizer of a liquid crystal panel with an acrylic tackiness agent (No. 7, manufactured by Nitto Denko Corporation, thickness: 25 μm). The occurrence of scratches or the like on the vapor deposited surface was able to be prevented and the handling capability was thus improved by bonding the vapor deposited side to the liquid crystal panel.

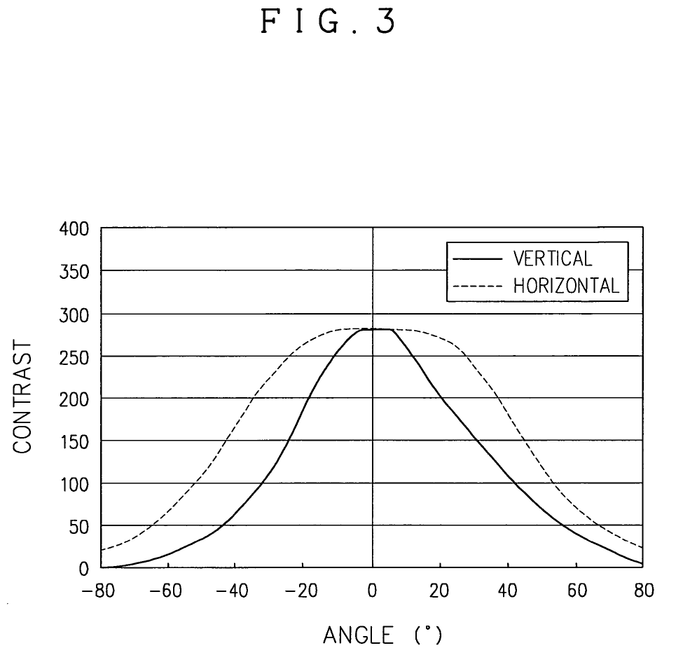

With the above arrangement, only the light producing a high-quality display could be retrieved. Then, as a tacky adhesion material (equivalent to the viewing angle widening element) of the display-side polarizer of the TFT liquid crystal panel, a light-diffusion, tacky adhesion material having a haze value of 88% (a front diffuser manufactured by Nitto Denko Corporation, thickness: about 30 μm (a material with SiO₂ spherical particles of φ4 μm dispersed in an acrylic tackiness agent (refractive index: 1.47))) was disposed. The viewing angle characteristics of the liquid crystal display device resulting from this arrangement is illustrated in FIG. 3. As illustrated in FIG. 3, it has been found that the viewing angle is widened and a good visual recognition region is expanded.

### Example 2

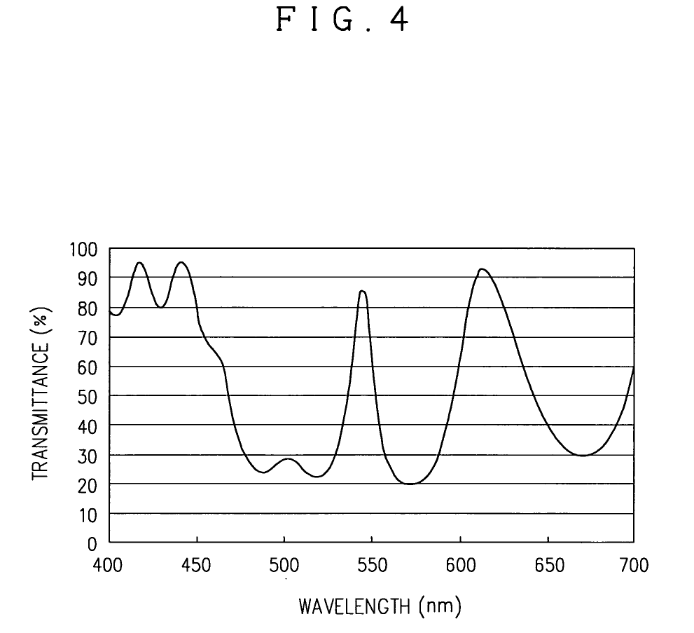

A fluorinated acrylate resin (LR202B manufactured by Nissan Chemical Industrials, Ltd.) as a low refractive index material, and an acrylate resin with ultrafine particles of a high refractive index inorganic material embedded therein (DeSolite manufactured by JSR Corporation) as a high refractive index resin were respectively used. A total of twenty-one layers of them having designed thicknesses shown in Table 2 were laminated on a substrate (TAC film (TD-TAC)) manufactured by Fuji Photo Film Co., Ltd.) by multilayer thin film deposition so as to prepare a bandpass filter having the transmission spectral characteristics, as illustrated in FIG. 4. In other words, a sol-gel film (nd=1.4) as a low refractive index resin and a hard coat resin (nd=1.7) with ZrO₂ super fine particles embedded therein as a high refractive index resin were respectively used. They were laminated on a TAC film as a substrate having a thickness of 80 μm by multilayer thin film deposition. The bandpass filter was thus prepared.

TABLE 2

| | REFRACTIVE | FILM |
|---|---|---|
| | INDEX | THICKNESS |
| LAYER | nd | [nm] |
| 21 | 1.71 | 78.69 |
| 20 | 1.40 | 94.91 |
| 19 | 1.71 | 76.47 |
| 18 | 1.40 | 91.13 |
| 17 | 1.71 | 209.91 |
| 16 | 1.40 | 86.91 |
| 15 | 1.71 | 73.47 |
| 14 | 1.40 | 90.1 |
| 13 | 1.71 | 187.19 |
| 12 | 1.40 | 90.48 |
| 11 | 1.71 | 79.55 |
| 10 | 1.40 | 100 |
| 9 | 1.71 | 83.27 |
| 8 | 1.40 | 102.99 |
| 7 | 1.71 | 85.58 |
| 6 | 1.40 | 106.79 |
| 5 | 1.71 | 88.36 |
| 4 | 1.40 | 102.94 |
| 3 | 1.71 | 382.65 |
| 2 | 1.40 | 113.23 |
| 1 | 1.71 | 90.23 |

SUBSTRATE

An acrylic hard coat resin with spherical melamine resin fine particles of Φ4 μm embedded therein was deposited on a surface of the bandpass filter on the backlight side so as to form a layer that has an uneven surface configuration for preventing the occurrence of a Newton ring, as well as having the light-diffusing capability. The layer thus formed omitted the necessity to dispose a diffusing plate on the side of the backlight, improved the surface hardness of the bandpass filter, and significantly improved the handling capability.

With the bandpass filter disposed on a conventional, non-directional backlight, it was possible to collimate the light transmitted through the bandpass filter to about ±20° relative to the front and hence retrieve only the light of a high-quality display region from the liquid crystal cell, in the same manner as in Example 1.

Further, a prism sheet with prisms arrayed at a pitch of 30 μm was disposed as the viewing angle widening element on the display side of the liquid crystal cell. In this arrangement, the prism sheet was disposed with an inclination angle of about 15° relative to the liquid crystal cell in order to prevent the occurrence of Moire fringes relative to the black matrix.

Since the bandpass filter is used as the collimating element in the above arrangement, periodic modulation of the brightness of the collimated light does not exist. Accordingly, the arrangement of the viewing angle widening element is made in consideration of only the relationship with the black matrix, enabling ease of determination of the arrangement and a high quality display without inversion in gradation within ±50° range.

### Example 3

A selective-reflection, circular polarizing film 1 was prepared, which film reflects right-circular polarized light in selective reflection wavelength ranges of 440 nm to 490 nm, 550 nm to 600 nm and 615 nm to 700 nm, respectively for emission wavelengths of 435 nm, 545 nm and 610 nm of the spectrum of a three-band cold cathode lamp. When preparing the film 1, three types of liquid crystal mixtures were prepared with reference to the disclosure of European Patent Application Publication No. 834754 so as to respectively have selective reflection center wavelengths of 480 nm, 550 nm and 655 nm. Specifically, a nematic monomer A having the following chemical formula (1) and a chiral monomer B having the following chemical formula (2) (which monomer is formed symmetrically in mirror image fashion relative to a corresponding one described in European Patent Application Publication No. 834754) were respectively synthesized.

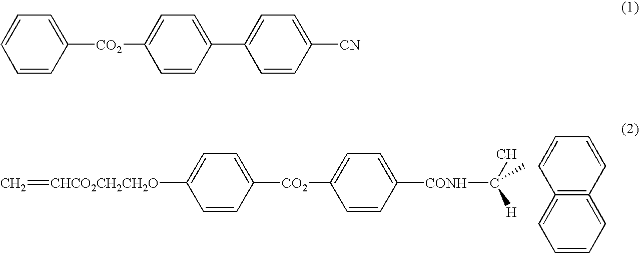

Then, the liquid crystal compositions A and B were mixed at the following ratios according to each selective reflection center wavelength. Specifically, the mixing was made at the ratio of composition A/composition B=9.81 for a selective reflection center wavelength of 480 nm, 11.9 for a selective reflection center wavelength of 560 nm, and 14.8 for a selective reflection center wavelength of 655 nm.

Each of the above mixtures was used to prepare a 33 wt. % tetrahydrofran solution, which was nitrogen purged in an environment at a temperature of 60° C., added a 0.5 wt. % reaction initiator (azobisisobutyronitrile), and subjected to a polymerization treatment. The resulting polymerized materials were reprecipitated, separated and purified by diethyl ether.

As substrates to which the polymerized materials are deposited, a PET film having a thickness of 75 μm was used. A PVA layer having a thickness of about 0.1 μm was deposited on the surface of each substrate, which was in turn rubbed with rubbing cloth of rayon.

Each of the polymerized materials was used to prepare a 10 wt. % methylene chloride solution, which was in turn deposited on each of the substrates with a wire bar so as to have a dry thickness of about 1 μm. After the deposition, they were dried at 140° C. for 15 minutes. After this drying treatment was completed, liquid crystal was cooled and solidified at a room temperature. Thus, a liquid crystal thin film was produced.

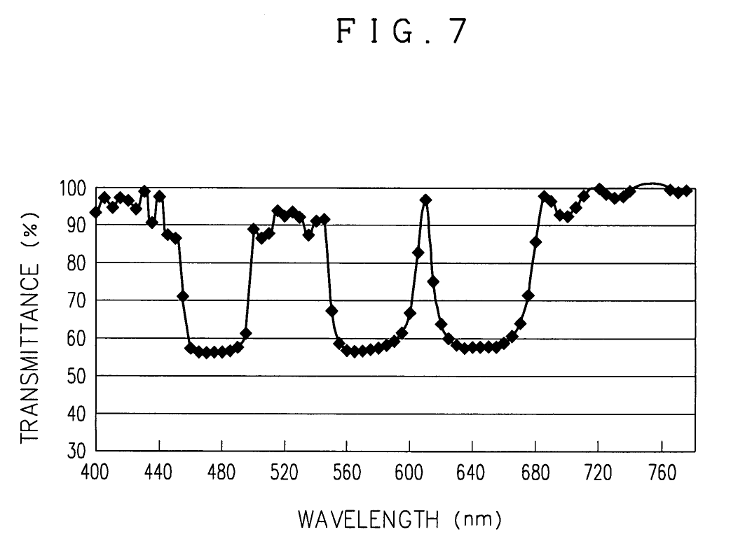

The polymerized materials, which were respectively polymerized at the above ratios, were thus subjected to the above processes so as to prepare liquid crystal thin films respectively corresponding to the selective reflection center wavelengths. The liquid crystal thin films were then bonded to each other with an isocyanate adhesive, while removing a PET film according to needs and circumstances. The liquid crystal thin films were laminated to each other in three layers so as to be aligned in sequence from the short-wavelength side. Whereby, a selective-reflection, circularly polarizing film, which has a complex layer structure of liquid crystal having a thickness of about 5 μm was prepared. Transmission spectral characteristics of the thus prepared selective-reflection, circularly polarizing film 1 are illustrated in FIG. 7.

On the other hand, a NIPOCS film (PCF400) manufactured by Nitto Denko Ltd. was used as a film 2 that reflects left-circular polarized light. This film is a circularly polarized light reflection polarizer which is conventionally used for the purpose of improving the brightness.

The film 1 and the film 2 were bonded together and laminated to a quarter wavelength plate, and then bonded to the polarizer so as to have both the transmission axes matched to each other. Thus, the bandpass filter has the same structure as that of the bandpass filter (optical element) disclosed in Japanese Patent Application No. 2001-60005, and it was found that the light transmitted through the bandpass filter is collimated to about ±15° relative to the front for the above three wavelengths.

The light utilization efficiency of the backlight was improved by about 1.5 times in comparison with Example 1 and Example 2 by the bandpass filter, that is, by the utilization of circular dichroism. A film with a haze value of 88%, which film being capable of widening the viewing angle with causing substantially no backscattering, was laminated on the display side of the liquid cell and light coming from the bandpass filter was transmitted therethrough. As a result, there was produced a uniform, high quality display with causing no uniform inversion in gradation within the viewing angle.

### Example 4

In place of the light-diffusion, tacky adhesion material of Example 1, a close-packed microlens type, viewing angle widening film with particles of φ100 μm was laminated. Moire fringes were formed between a lens of the viewing angle widening film and the black matrix of the liquid crystal display device and therefore Moire fringes were removed by rotating the bonding angle of the viewing angle widening film. In this Example, Moire fringes or interference patterns were not formed relative to the bandpass filter as the collimating element. Thus, a high quality display could be produced.

### Comparative Example 1

Light coming from the backlight was collimated by using a microlouver-type collimating film (width of each light-shielding louver: 13 μm, pitch interval: 250 μm). The total thickness after laminating two films with their aligning directions crossing each other was 1.4 mm and the light transmitted through the film was collimated to ±10° relative to the front.

Then, a viewing angle widening film made up of a Φ100 μm microlens array film was disposed on the display side of the liquid crystal cell.

The collimating film was disposed with its angle adjusted so as not to form Moire fringes between the collimating film and the black matrix. Moire fringes were not formed relative to the black matrix but formed relative to the viewing angle widening film. The viewing angle widening film was rotated at an attempt to reduce Moire fringes relative to the collimating film, but Moire fringes were formed between the viewing angle widening film and the black matrix according to the rotating angle. Thus, the display quality deteriorated.

### Comparative Example 2

As the collimating element, a prism array with a pitch interval of 50 μm was used.

Then, a viewing angle widening film made up of a φ100 μm microlens array film was disposed on the display side of the liquid crystal cell.

The collimating film was disposed with its angle adjusted so as not to form Moire fringes between the collimating film and the black matrix. Moire fringes were not formed relative to the black matrix but formed relative to the viewing angle widening film. The viewing angle widening film was rotated at an attempt to reduce Moire fringes relative to the collimating film, but Moire fringes were formed between the viewing angle widening film and the black matrix according to the rotating angle. Thus, the display quality deteriorated.

As described above, according to the liquid crystal display device of the present invention, it includes the collimating element for transmitting the collimated light to the liquid crystal cell and the viewing angle widening element for diffusing the light transmitted through the liquid crystal cell and widening the viewing angle, the liquid crystal display device provides a wide viewing angle. Also, with the collimating element which does not have a periodic pattern structure that allows Moire fringes or interference patterns seen in optical observation from a display side to be formed relative to a periodic pattern structure of another optical member (the liquid crystal cell, the viewing angle widening element or the like) of the liquid crystal display device, the liquid crystal display device provides a high quality display without occurrence of Moire fringes or interference patterns.

Particularly, when the collimating element is provided in the form of a bandpass filter, the transmission wavelength band of the bandpass filter is optimized so that only the light collimated toward the front side can be transmitted. Since the bandpass filter is formed such as by vapor deposition of a material into a multilayer structure, it does not have a periodic pattern structure that allows Moire fringes or interference patterns to be formed relative to a periodic pattern structure of another optical member of the liquid crystal device. This is also significantly advantageous in the fact that the vapor deposition of a material can realize a thin layered structure, a thin bandpass filter and hence a thin, low-profile liquid crystal display device.

1. A liquid crystal display device comprising:
a backlight;
a collimating element for collimating incoming light from the backlight and transmitting the collimated light;
a liquid crystal cell for allowing the light coming from the collimated element to pass therethrough; and
a viewing angle widening element for widening the viewing angle by diffusing the light transmitted through the liquid crystal cell;
wherein the collimating element does not have a periodic pattern structure that allows Moire fringes or interference patterns seen in optical observation from a display side to be formed relative to a periodic pattern structure of another optical member of the liquid crystal display device.

2. The liquid crystal display device according to claim 1, wherein the collimating element is a bandpass filter.

3. The liquid crystal display device according to claim 2, wherein the bandpass filter is made of a cholesteric liquid crystal polymer material.

4. The liquid crystal display device according to claim 2, wherein the bandpass filter is formed by vapor deposition of a material into a multilayer structure.

5. The liquid crystal display device according to claim 2, wherein the bandpass filter is formed by laminating resin materials respectively having different refractive indexes into a multilayer structure.

6. The liquid crystal display device according to claim 5, wherein the multilayer structure is achieved by extruding the resin materials into a multilayer structure and then drawing the same.

7. The liquid crystal display device according to claim 5, wherein the multilayer structure is achieved by thin film deposition of the resin materials.

8. The liquid crystal display device according to claim 1, wherein the collimating element has a thickness of not more than 200 μm.

9. The liquid crystal display device according to claim 1, wherein the collimation degree of the light coming from the collimating element is within ±20°.

10. The liquid crystal display device according to claim 1, wherein a light source of the backlight emits a bright-line spectrum.

11. The liquid crystal display device according to claim 10, wherein the light source is a three-band cold cathode lamp.

12. The liquid crystal display device according to claim 10, wherein the light source is a light emitting diode.

13. The liquid crystal display device according to claim 10, wherein the light source is an electroluminescence device.

14. The liquid crystal display device according to claim 1, wherein the viewing angle widening element is a diffusing plate that does not substantially cause backscattering and does not substantially destroy a polarized state.
